(19) United States
(12) Patent Application Publication
(10) Pub. No.: US 2011/0001799 A1
(43) Pub. Date: Jan. 6, 2011

(54) 3D SENSOR

(75) Inventors: Bernd ROTHENBERGER, Breisach (DE); Shane MACNAMARA, Ebringen (DE); Ingolf BRAUNE, Gundelfingen (DE)

Correspondence Address: THE NATH LAW GROUP, 112 South West Street, Alexandria, VA, 22314, US

(73) Assignee: SICK AG, Waldkirch (DE)

(21) Appl. No.: 12/829,058

(22) Filed: Jul. 1, 2010

(30) Foreign Application Priority Data
Jul. 6, 2009 (EP) 09 164664.6

(51) Int. Cl. H04N 13/02; H04N 7/18

(52) U.S. Cl. 348/47; 348/159; 348/E13.074; 348/E07.085

(57) ABSTRACT

A 3D sensor (10) having at least one image sensor (14) for the generation of image data of a monitored region (12) as well as a 3D evaluation unit (28) are provided, the evaluation unit (28) is adapted for the calculation of a depth map having distance pixels from the image data and for the determination of reliability values for the distance pixels. In this respect a gap evaluation unit (28) is provided which is adapted to recognize regions of the depth map with distance pixels whose reliability value does not satisfy a reliability criteria as gaps (42) in the depth map and to evaluate whether the depth map has gaps (42) larger than an uncritical maximum size.

The invention relates to a 3D sensor and a 3D monitoring process in accordance with the preamble of claim 1 and claim 11 respectively.

Cameras have been used for a long time for monitoring and are increasingly also being used in safety technology. A typical safety technical application is the safeguarding of a dangerous machine, such as a press or a robot, where on interference of a body part in a dangerous area around the machine a safeguarding occurs. Depending on the situation this can be the switching off of the machine or the movement into a safe position.

The continuously increasing availability of high performance computers enables real time applications such as monitoring tasks to be based on three-dimensional image data. A known method for obtaining said data is stereoscopy. In this respect images of the scenery are obtained from slightly different perspectives with a receiving system which essentially comprises two cameras at a distance from one another. In the overlapping image areas like structures are identified and from the disparity and the optical parameters of the camera system, distances and thus a three-dimensional image and/or a depth map are calculated by means of triangulation.

With respect to common safety technical sensors such as scanners and light grids stereoscopic camera systems offer the advantage that comprehensive depth information can be determined from a two-dimensionally recorded observed scenery. With the aid of the depth information protected zones can be determined more variably and more exactly in safety technical applications and one can distinguish more and preciser classes of allowed object movements. For example, it is possible to identify as non-dangerous movements of the actual robot at the dangerous machine or also movements of a body part passing the dangerous machine in a different depth plane. This would not be distinguishable from an unauthorized interference using a two-dimensional system.

Another known method for the generation of three-dimensional image data is the time of flight process. In a specific embodiment the image sensor has PMD pixels (photon mix detection) which respectively determine the time of flight of emitted and the re-received light via a phase measurement. In this respect the image sensor also records distance data in addition to a common two-dimensional image.

In the frame work of safety engineering for a reliable safety function, with respect to two-dimensional cameras, there is the added requirement of not only safely detecting an interference from the provided image data, but to initially even generate a high quality and sufficiently deep depth map with reliable distance values, i.e. to have a reliable distance value available for each relevant image range and in the ideal case to have almost every image point. Passive systems, i.e. those without their own illumination, merely enable the obtaining of thinly occupied depth maps. Stereoscopic algorithms of passive systems only deliver a reliable distance value at object contours or shaded edges and where sufficient natural texture or structure is present.

The use of a specially adapted structured illumination may considerably improve this situation, as the illumination makes the sensor independent of natural object contours and object textures. However, there are also partial regions in the depth maps produced thereby, in which this depth is not correctly measured due to photometric or geometric circumstances of the scene.

To initially even identify these partial regions, the distance pixels of the depth map have to be evaluated. A measure for the reliability of the estimated distances is given by many stereoscopic algorithms by the depth map itself, for example, in the form of a quality map which has a reliability value for every distance pixel of the depth map. A conceivable measure for the reliability is the weighting of the correlation of the structure elements in the right image and in the left image, which were recognized as the same image elements from the different perspectives of the two cameras in disparity estimations. Frequently further filters are additionally connected downstream to check the requirements for the stereoscopic algorithm or to verify the estimated distances.

Unreliably determined distance values are highly dangerous in safety related applications. If the positioning, size or distance of an object is wrongly estimated this may possibly cause the switching off of the source of danger not to occur, since the interference of the object is wrongly classified as uncritical. For this reason typically only those distance pixels are used as the basis for the evaluation which were classified as sufficiently reliable. The prior art however, knows no solutions on how to deal with partial regions of the depth map without reliable distance values.

It is therefore the object of the invention, to provide a 3D system which can interpret incompletely occupied depth maps.

This object is satisfied by a 3D sensor in accordance with claim 1 and a 3D monitoring process in accordance with claim 11.

The solution in accordance with the invention is based on the principle of identifying and evaluating gaps in the depth map. To preclude safety risks, regions of the depth map in which no reliable distance values are present have to be evaluated as blind spots and thus ultimately have to be evaluated as rigorously as object interferences. These gaps then no longer lead to safety risks. Only when no gap is large enough that an unauthorized interference can be concealed by it is the depth map suitable for a safety related evaluation.

The invention has the advantage that the 3D sensor can also cope with measurement errors or artifacts in real surroundings very robustly. In this respect a high availability is achieved with full safety.

Reliability criteria can be a threshold requirement on a correlation measure, but can also be further filters for the evaluation of the quality of a stereoscopic distance measurement. The uncritical maximum size for a gap depends on the desired resolution of the 3D sensor and is orientated according to the detection capability which should be achieved in safety technical applications, i.e. whether e.g. finger protection (e.g. 14 mm), arm protection (e.g. 30 mm) or body protection (e.g. 70 mm up to 150 mm) should be guaranteed.

The gap evaluation unit is preferably adapted for an evaluation of the size of gaps with reference to a largest possible geometric shape inscribed into the gap, in particular with reference to the diameter of an inner circle or of the diagonal of an inner rectangle. The frequency is thereby minimized in which theses gaps classified critical are detected and the availability is thus further increased. The ideal geometric shape would be an inner circle to ensure the resolution of the sensor. To minimize the calculation demand other shapes can also be used, with rectangles or specifically squares being particularly simple and therefore fast to evaluate due to the grid-shaped pixel structure of typical image sensors. The use of the diagonal as their size measure is not necessary, but is a safe upper limit.

Advantageously the 3D sensor has an object evaluation unit which is adapted to detect contiguous regions of distance pixels as objects and to evaluate the size of an object with reference to a smallest possible geometric shape surrounding the object, in particular with reference to the diameter of a circumference or the diagonal of a surrounding rectangle. As a rule, the contiguous regions in this respect consist of valid distance pixels, i.e. those whose reliability value fulfils the reliability criterion. Contiguous should initially be understood such that the distance pixels themselves are neighboring to one another. With additional evaluation cost and effort a neighboring relationship in the depth dimension can also be requested; for example, a highest distance threshold of the depth values. The surrounded rectangle is also frequently referred to as a bounding box.

Objects are accordingly preferably evaluated by a surrounding geometric shape, gaps by an inscribed geometric shape, that is objects are maximized and gaps minimized. This is a fundamental difference in the measurement of objects and of gaps which takes account of their different nature. It is namely the aim to under no circumstances overlook an object, while as many evaluatable depth maps and regions of depths maps as possible should be maintained despite gaps.

The object evaluation unit is preferably adapted to generate a binary map in a first step, said binary map records in every pixel whether the reliability value of the associated distance pixel satisfies the reliability criterion and is thus occupied with a valid distance value or not, then, in a further step, defines partial objects in a single linear scanning run in that an occupied distance pixel without an occupied neighbor starts a new partial object and attaches occupied distance pixels with at least one occupied neighbor to the partial object of one of the unoccupied neighbors and, in a third step, partial objects which have at most a preset distance to one another are combined to the objects. This procedure is very fast and is nevertheless in the position to cluster every possible object shape to a single object.

The gap evaluation unit and/or the object evaluation unit is/are preferably adapted to overestimate the size of a gap or an object, in particular by projection onto the remote border of the monitored region or of a work region. This is based on a worst case assumption. The measured object and/or the measured gap could hide an object lying further back from the view of the sensor and thus possibly larger objects are hidden due to the perspective. This is taken into account by the projection using perspective size matching so that the sensor does not overlook any objects. In this respect a remote border is to be understood in some applications as the spatially dependent boundary of the monitored region of interest and not as the maximum range of sight, for instance.

The gap evaluation unit and/or the object evaluation unit is/are preferably adapted to calculate gaps or objects of the depth map in a single linear scanning run in real time. The term linear scanning run relates to the typical read-out direction of an image sensor. In this manner a very fast evaluation of the depth map and therefore a short response time of the sensor is made possible.

The gap evaluation unit is preferably adapted to determine the size of the gaps by successively generating an evaluation map s in accordance with the calculation rule

$$s ( x , y ) = \{ \begin{matrix}0 & when d ( x , y ) \neq 0 \\ 1 + min ( \begin{matrix}\begin{matrix}s ( x - 1 , y ) , \\ s ( x - 1 , y - 1 ) ,\end{matrix} \\ s ( x , y - 1 )\end{matrix} ) & when d ( x , y ) = 0\end{matrix}$$

with d(x,y)=0 being valid precisely when the reliability value of the distance pixel at the position (x,y) of the depth map does not satisfy the reliability criterion. This is a method which works very fast without a loss of accuracy with a single linear scanning run.

In a preferred embodiment at least two image sensors are provided for the reception of image data from the monitored region from different perspectives, with the 3D evaluation unit being adapted as a stereoscopic evaluation unit for the generation of the depth map and the reliability values using a stereoscopic method. Stereoscopic cameras have been known for a comparatively long time so that a number of reliability measures is available to ensure robust evaluations.

In an advantageous embodiment a warning unit or cut-off unit is provided by means of which, on detection of gaps or of prohibited objects larger than the uncritical maximum size, a warning signal or a safety cut-off command can be issued to a dangerous machine. The maximum size of gaps and objects is generally the same and is orientated on the detection capability and/or on the protection class to be achieved. Maximum sizes of gaps and objects differing from one another are also conceivable. The measurement of gaps and objects, however, preferably takes place differently, namely once using an inner geometric shape and once using an outer geometric shape. The most important safety technical function for the safeguarding of a source of danger is realized using the warning unit and cut-off unit. Due to the three-dimensional depth map distance dependent protection volumes can be defined and the apparent change of the object size due to the perspective can be compensated by means of projection as has already been addressed.

Preferably a work region is preset as a partial region of the monitored region and the 3D evaluation unit, the gap evaluation unit and/or the object evaluation unit only evaluates the depth map within the work region. The calculation effort, time and cost is thus reduced. The work region can be preset or be changed by configuration. In the simplest case it corresponds to the visible region up to a preset distance. A more significant constraint and thus a higher gain in calculation time is offered by a work region which comprises one or more two-dimensional or three-dimensional protected fields. If the protected fields are initially completely object-free, then the evaluation of unauthorized interferences is simplified if each interfering object is simply unauthorized. However, dynamically determined allowed objects, times, movement patterns and the like can also be configured or taught to differentiate between unauthorized and permitted object interferences. This requires increased evaluation time effort and cost; however, it therefore offers a considerably increased flexibility.

The method in accordance with the invention can be further adapted in a similar manner and in this respect shows similar advantages. Such advantageous features are described by way of example but not exclusively in the subordinate claims dependent on the independent claims.

The invention will also be described by way of example in the following with reference to further features and advantages, with reference to embodiments and to the enclosed drawing. The Figures of the drawing show:

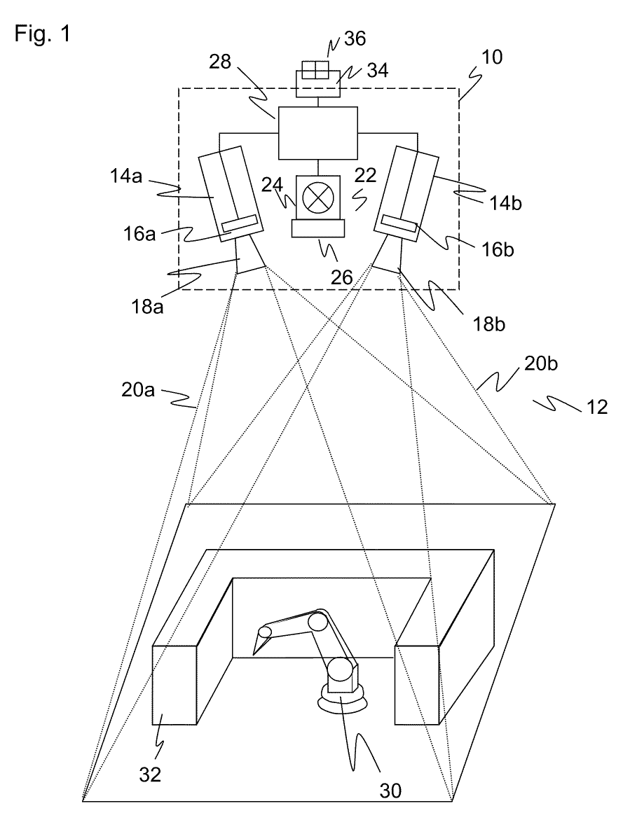

FIG. 1 a schematic spatially, complete illustration of a 3D sensor;

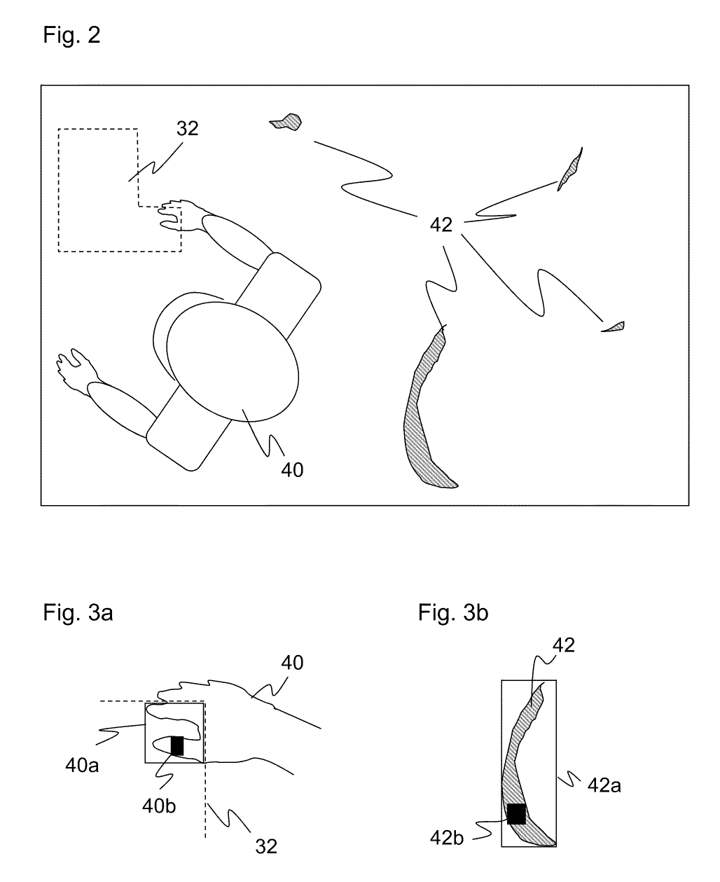

FIG. 2 a schematic depth map with objects and gaps;

FIG. 3a a section of the depth map in accordance with FIG. 2 for the explanation of the object detection and object measurement;

FIG. 3b a section of the depth map in accordance with FIG. 2 for the explanation of the gap detection and gap measurement;

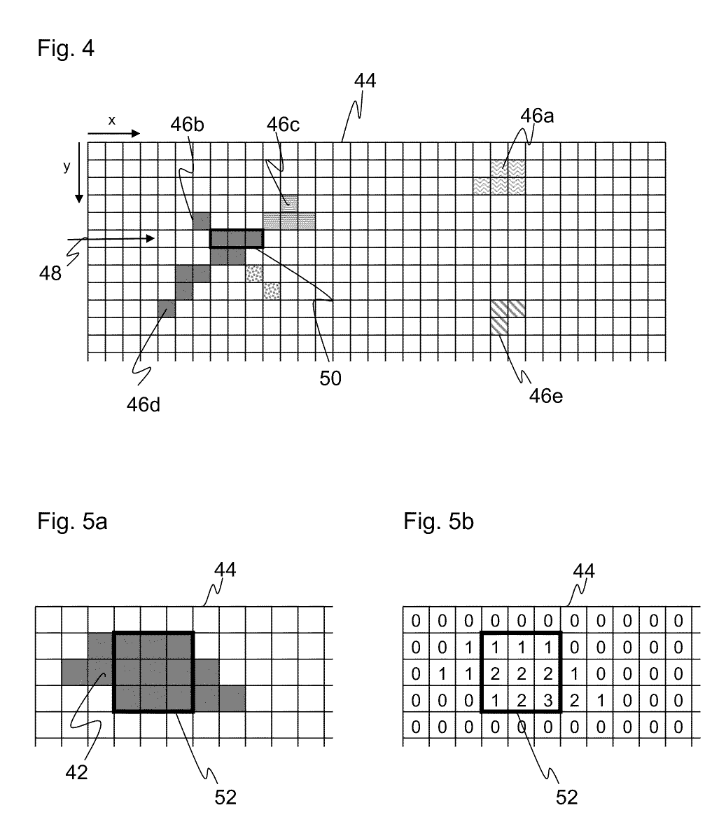

FIG. 4 a schematic illustration of an object map for the explanation of object clustering;

FIG. 5a a schematic sectional illustration of a gap map and

FIG. 5b a schematic sectional illustration of an s map for the measurement of the gap of FIG. 5a.

In a schematic three-dimensional illustration FIG. 1 shows the general setup of a 3D safety sensor 10 in accordance with the invention based on the stereoscopic principle, which is used for safety-related monitoring of a space region 12. The region extension in accordance with the invention can also be used for depth maps which are obtained from an imaging method different from stereoscopy. As described in the introduction light propagation time cameras are included in these. Moreover, the use of the invention is not restricted to safety technology, since nearly every 3D image-based application profits from more reliable depth maps. Following this preliminary remark, the further application areas will be described in detail in the following using the example of a stereoscopic 3D safety camera 10. The invention is largely independent of how the three-dimensional image data is obtained.

In the embodiment in accordance with FIG. 1 two common modules 14a, 14b are mounted at a known fixed distance to one another and respectively record images of the spatial region 12. Each camera is provided with an image sensor 16a, 16b typically a matrix-shaped recording chip which records a rectangular pixel image, for example a CCD sensor or a CMOS sensor. The image sensors 16a, 16b are associated with a respective lens 18a, 18b having a respective imaging optical system, which in practice can be realized as any known imaging lens. The viewing angle of these lenses is illustrated in FIG. 1 by dashed lines, which respectively form a viewing pyramid 20a, 20b.

A lighting unit 22 is provided in the middle between the two image sensors 16a, 16b, with this spatial arrangement only being understood as an example and the imaging unit can also be arranged asymmetrically or even outside of the 3D safety camera 10. The lighting unit 22 has a light source 24, for example, one or more lasers or LEDs, as well as a specimen generating element 26 which can be adapted, e.g. as a mask, a phase plate or a diffractive optical element. Thus the lighting unit 22 is in a position to illuminate the space region 12 using a structured pattern. Alternatively, no lighting or homogeneous lighting is provided, to evaluate the natural object structures in the space region 12. Also mixed shapes with different lighting scenarios are plausible.

A control 28 is connected to the two image sensors 16a, 16b and to the lighting unit 22. The structured lighting pattern is generated by means of the control 28 and if required is varied in its structure or intensity and the control 28 receives image data from the image sensors 16a, 16b. With the aid of a stereoscopic disparity estimation three-dimensional image data (distance image, depth map) of the space region 12 are calculated from the image data by the control 28. The structured imaging pattern therefore serves for a good contrast and a distinctly allocatable structure of each image element in the illuminated space region 12. It is non-self similar with the most important aspect of the non-self similarity being the at least local, preferably global lack of translation symmetries, in particular in correlation direction of the stereo algorithm so that no apparent displacement of image elements from images recorded with different perspectives are detected due to the illumination pattern elements which can cause errors in the disparity estimation.

A known problem can occur using two image sensors 16a, 16b in that structures can no longer be used which are aligned along the equipolar line, since the system cannot locally differentiate whether the structure in the two images are recorded displaced to one another due to the respective or whether merely a non-differentiable other part of the same parallel to the base of the stereo system aligned structure is compared. To solve this other embodiments of one or more further camera modules can be used which are arranged displaced with respect to the connection straight of the two original camera modules 14a, 14b.

Known and unexpected objects can be present in a space region 12 monitored by the safety sensor 10. For example, it can be a robot arm 30 as illustrated, but also be another machine, an operating person and others. The space region 12 offers a gateway to a source of danger, because it is a gateway region or because a dangerous machine 30 is itself present in the space region 12. To safeguard against these sources of danger, one or more virtual protection fields and warning fields 32 can be configured. They form a virtual fence surrounding the dangerous machine 30. It is possible to define three-dimensional safety and warning fields 32 so that a large flexibility arises, due to the three-dimensional evaluation.

The control 28 evaluates the three-dimensional image data with respect to unauthorized interferences. The evaluation rules can, for example prescribe that absolutely no object can be present in a protection field 32. Flexible evaluation rules are provided to differentiate between and unauthorized objects, e.g. by means of movement paths, patterns or contours, speeds or general work processes, which can both be either allowed from the outside either by configuration or teaching and also by means of evaluations, heuristics or classifications be exploited even during operation.

Should the control 28 recognize an unauthorized interference in a protected field then a warning is emitted via a warning unit or cut-off unit 34 which in turn can be integrated in the control 28, for example, the robot 30 can be stopped. Safety-related signals, i.e. in particular the cut-off signal are emitted via a safety output 36 (OSSD, Output Signal Switching Device). In this respect it depends on the application, whether a warning is sufficient, and/or a two step safeguard is provided with which it is initially warned and only on a continuous object interference or an even deeper penetration of the object is switched off. Instead of a cut-off the appropriate reaction can also be the immediate displacement into an undangerous park position.

To be suitable for safety related applications, the 3D safety camera 10 is adapted fail-safe. This means that dependent on the required safety class and/or category among others, that the 3D safety camera 10 itself can also test in cycles below the required reaction time, in particular also whether defects of the lighting unit 22 can be recognized and thus ensure that the illumination pattern is available in an expected minimum intensity and that the safety output 36 and also the warning unit or cut-off unit 34 are adapted safely, for example, on two channels. Also the control 28 is self-reliant, i.e. it evaluates on two channels or uses algorithms which can examine themselves. Such requirements are standardized for generally touch-free working safety units in the EN 61496-1 and/or the IEC 61496 as well as in the DIN EN ISO 13849 and the EN 61508. A corresponding standard for safety cameras is being prepared.

FIG. 2 schematically shows an exemplary scenario which is recorded and monitored by the 3D security camera 10. In which data of this scenery are recorded from the first image sensor and the second image sensor 16a, 16b from the two different perspectives. These image data are initially subjected to an individual pre-processing. In this respect the remaining discrepancies are deskewed from the required central perspective which is introduced by the lenses 18a, 18b due to non-ideal optical properties. Descriptively spoken a chessboard with light and dark squares should be imaged as such and discrepancies thereof should be compensated by means of a model of the optical system by configuration or by initial teaching. A further known example for preprocessing is a border energy decrease which is compensatable by increasing the brightness at the borders.

The actual stereo algorithm then works on the preprocessed individual images. Structures of one image are correlated with a different translational displacement with structures of the other image and the displacement is used with the best correlation for disparity estimation. Which standard the correlation evaluates is not relevant in principle also when the performance of the stereoscopic algorithm is particularly high for certain standards. Exemplary named correlation measures are SAD (Sum of Absolute Differences), SSD (Sum of Squared Differences) or NCC (Normalized Cross Correlation). The correlation not only offers a disparity estimation from which a distance pixel of the depth map results by using elementary trigonometric considerations using the separation distance of the cameras 14a, 14b, but simultaneously a weighting measure for the correlation is given. Additional quality criteria are plausible, for example a texture filter, which examines whether the image data have sufficient structure for an unambiguous correlation, a neighboring maximum filter, which tests the ambiguity of the found correlation optimum, or a third left right filter, in which the stereo algorithm is used a second time on the first and second images which are swapped with one another, to minimize mistakes by occlusion, i.e. image features which were seen from the perspective one camera 14a, 14b but not from the perspective of the other camera 14b, 14a.

The stereo algorithm then supplies a depth map which has a distance pixel with a distance value for each image point, as well as a quality map which allocates one or more reliability values as a measure of confidence to each distance pixel. On the basis of the reliability values it is then decided whether the respective depth value is allowable for the further evaluation or not. This evaluation could be carried out continuously, however, for the practical further processing a binary decision is preferred. In this respect each value of the depth map which does not satisfy the reliability criterion is set to an invalid distance value such as −1, NIL or the like. The quality map has thus fulfilled its task for the further process, which works purely only on the depth map.

The scenario of FIG. 2 can also be interpreted as a simple depth map. A person 40 was completely detected with valid distance pixels. In a true to detail illustration of a depth map the person 40 should e.g. be color-coded, with the color representing the non-illustrated detected depth dimension. In several regions 42 no valid distance value is available. Such invalid regions 42 are referred to as defects or gaps in the depth map. For a reliable object definition a 3D imaging method is required in that such gaps 42 only occupy small and if possible only a few positions of the depth map, since each gap 42 possibly covers an unidentified object. In connection with FIG. 5 it will be described in detail below how such gaps are evaluated to ensure these conditions.

The total volume of the visual range of the 3D safety camera 10 is referred to as a work volume, in which data is obtained and depth values can be determined. It is not required to monitor the total visual range for many applications. For this reason a restricted work volume is preconfigured, for example in the form of a calibrated reference depth map in which one or more work volumes are defined. It is frequently sufficient to limit the further processing to the protected area 32 as a restricted work volume for safety-relevant applications. In its simplest form the restricted work volume is merely a distance area at a maximum work distance over the full visual range of the distance sensor. Thus, the reduction of the data volume is restricted to exclude distant objects from the measurement.

The actual monitoring object of the 3D safety camera consists in identifying all objects, such as the person 40 or their extremities which are present in the work volume or which move into the work volume and to determine their size. Dependent on parameters such as position, size or movement path of the object 40, the control 28 then decides whether a cut-off signal should be emitted to the monitoring machine 30 or not. A simple set of parameters are static protector fields 32 in which each object 40 exceeding a minimum size leads to a cut-off. However, the invention also includes significantly more complicated rules, such as dynamic protected fields 32 which are variable in position and size or allowed objects 40 which at certain times are allowed or certain movement patterns are allowed also in the protected fields 32. A few of such exceptions are known as “muting” and “blanking” for touch-free working protective units.

The object detection has to occur very fast. Each complete evaluation of a depth map is referred to as a cycle. In practical safety-relevant applications several cycles are required within a response period, for example for self testing of the image sensors, or to evaluate different imaging scenarios. In this respect typical response times are of the order of magnitude of less than 100 ms, for example, also only 20 ms. To ideally use the calculation capacities, it is preferred to not read-in a complete image, but that the evaluation already starts as soon as the first image line or the first image lines are present. In a pipeline structure the processed lines are passed on to a subordinate step in each intermediate step. Thus, at any given time several image lines are present in different processing steps. The pipeline structure works fastest using algorithms which get by with a simple line-wise processing, as for others such as one-pass processes, have to be waited for until all the image data of a frame has been read in. Such one-pass methods also save system memory and reduce the calculation effort in time, effort and cost.

It should be noted for the object detection that a small object 40 in the foreground can cover a larger more distant object 40. To account for the worst case each object 40 is projected under perspective size matching onto the remote border of the work volume. Analogously the sizes of gap 42 are overestimated. A particularly critical case is when a gap 42 neighbors an object 40. This is to be accounted for, for the maximum allowable object size, for example by reducing this by the size of the gap.

The FIGS. 3a and 3b exemplary explain the determination and measurement of objects 40 and/or gaps 42. The object 40 is in this respect only evaluated in the relevant intersection area of the protected field 32. Since the requirements of safety standards merely disclose a single size value, for example 14 mm for finger protection, the objects 40 have to be assigned as scalar size value. For this the measurements such as the pixel number or a definition of the diameter known from geometry, which in extended definition is also valid for arbitrary shapes. For the practical application usually a comparison with a simple geometric shape is sufficient.

In this respect a fundamental difference between the evaluation of objects 40 and gaps 42 is found. In accordance with the invention the object 40 is measured with a surrounding rectangle 40a, the gap is measured by a inscribed rectangle 42b. In FIG. 3a on the other hand, one can recognize why the evaluation of an object 40 by means of an inscribed rectangle 40a would be a bad choice. Although a plurality of fingers interfere with the protected field 32, the largest inscribed rectangle 40a would only have the dimension of a single finger. A 3D safety camera, which is adapted for hand protection but not for finger protection would still tolerate this interference wrongly. Similarly, the surrounding rectangle 42a for the gap evaluation is not ideal, particularly for long and thin gaps 42 as illustrated. This gap 42a is only critical, when an object 40 above a critical maximum size could be hidden in it. The surrounding rectangule 42a overestimates the gap 42 significantly and therefore unnecessarily reduces the availability of the 3D safety camera 10. The so described non-ideal behavior could also be avoided by more demanding geometrical measures which however are less accessible for linear one-pass evaluations.

With reference to FIG. 4 a line-orientated method in accordance with the invention should now be described, with which objects of arbitrarily complicated outer contour can be clustered in a single run. The linear scanning process enables the integration into the frequently mentioned real time evaluation by pipelines. A group of distant pixels is understood by a cluster which pixels are combined successively or by application of a distance criterion as an object or partial object.

The depth map is delivered line-wise for the object recognition. The object recognition works on a simple depth map. For this initially all distance pixels to gaps 42 and distance pixels outside of the restricted work volume are set to invalid, for example 0 or −1 and all distance pixels satisfying the quality criterion are set to valid, for example 1. Invalid distance pixels are not used by the object recognition.

Following this simplification the binary evaluation image is generated which shows the object in the work volume very clearly. As a rule clusters are formed from directly neighboring pixels. In FIG. 4 a grid 44 symbolizes the image memory in that a cutout of the binary evaluation image is illustrated. The binary evaluation image is processed line-wise and in each line from left to right. These clusters should be detected by the object recognition to e.g. determine a surrounding line, area, a pixel number or a geometric comparison form for the measurement of the size of the cluster. The pixel number is suitable for a presence decision, a cluster having less than a minimum number of pixels is thus not treated as an object.

Clusters are formed by the object recognition by a direct neighboring relationship to the eight surrounding pixels. FIG. 4 shows the five partial clusters 46a-e using different hatchings, as the object recognition will recognize these after completion. To explain this approach an arrow 48 points to a line which is currently being worked on. In contrast to the illustration this and the following lines have thus not been processed by the object recognition. In the current line, connected line object pieces 50 are combined. Following this it is attempted to attach such line object pieces 50 to an already present cluster of the previous line. If several partial clusters are available, such as is shown by the line indicated by the arrow 48, then an arbitrary choice of the line object piece 50 is deposited, for example on the first cluster 46b in the evaluation direction. Simultaneously, however, the neighborhood to all further earlier clusters is memorized in an object connection list, in the present case the cluster 46c. If there is no cluster 46a-e to which the line object part 50 can be attached then a new cluster is initiated.

Parallel to the clusterring the number of pixels whose depth value and pixel position is accumulated in an associated object memory in an object list and the surrounding rectangle of each cluster is determined. The significant sizes of the emerging partial objects are thus always available.

Following the processing of all lines partial clusters are combined with the aid of the object connection list, in the example the partial clusters 46b-d and also the object size for the total object are updated with little effort.

The actual object recognition is therefore concluded. Depending on the selected depth imaging method, objects are broken down in the depth map sometimes into two or more parts, i.e. they loose their direct pixel neighboring which presupposes the clustering. However, these parts are still spatially closely neighbored. By means of the object list the spatial proximity of the objects to one another is therefore judged optionally in a sub-ordinate step. If the partial objects fulfill a distance criterion then these are combined to an object analog to the connection of partial clusters.

From the object list the middle depth and the position of all objects is then known. From the diagonal of the surrounding rectangles and the middle object depth the maximum object size is calculated at a position. Of interest in the safety technology is, however, not only the object itself, but also whether a large object is hidden behind an uncritical small and close object, following projection of the object to the outermost border of the work volume or the restricted work volume. To exclude this case, the object is projected onto the remote border and correspondingly the required displacement is enlarged by percentage. The projection size and not the actual object size is then compared to the required uncritical maximum size to decide on a safety-related cut-off.

As has been frequently noted the gaps 42 are evaluated differently to the object 40. For this reason an own line-orientated method for the gap evaluation is used in accordance with the invention which shall now be explained with reference to FIGS. 5a and 5b. FIG. 5a shows a pixel colored grey for illustration as a gap 42.

For processing an additional evaluation map s is used. In this map the successive value at each position s(x,y) of the following calculation rule is established:

$$s ( x , y ) = \{ \begin{matrix}0 & when d ( x , y ) \neq 0 \\ 1 + min ( \begin{matrix}\begin{matrix}s ( x - 1 , y ) , \\ s ( x - 1 , y - 1 ) ,\end{matrix} \\ s ( x , y - 1 )\end{matrix} ) & when d ( x , y ) = 0\end{matrix}$$

In this respect d(x,y)=0 is valid when the depth value at the position (x,y) does not fulfill the reliability criterion. For a s value different from 0 in accordance with the second line of this calculation rule it can additionally be required, that (x,y) lies within the restricted work volume so that also gaps 42 outside the restricted work volume have no influence.

The calculation rule provided is valid for a processing direction line-wise from top to bottom and in each line from right to left. It is analogous to match this to different running directions by the depth map the three neighbors are respectively considered which have already been processed and thus have a definite s value. Neighbors not defined due to their border position have the s value of 0. The largest s value of each cluster corresponds to the edge length of the largest inscribed square after a completed gap movement, from which the other characteristics such as the diagonal can easily be calculated. The globally largest s value corresponds to the largest gap of the total depth map. In most applications it will depend on this global s maximum for a reliability evaluation, which s maximum has to be smaller than the critical maximum size so that the depth map is evaluatable for safety purposes. One can respectively variably carry forward the largest s value already during the run for the determination of the s map, so that it is available straightaway following the processing of the s map.

FIG. 5b shows the s values for the example of FIG. 5a. The entry “3” in the right lower corner of the largest inscribed square 52 is the largest value in the example of the only gap 42. In this respect the gap 42 is evaluated with the edge length 3 or the associated diagonal which can be transformed by known parameters of the image sensors 14a and 14b and of the lenses 16a, 16b into real size values. In analogy to the objects 40 also the gaps 42 are projected to the remote border in order to cover for the worst plausible case (worst case). It is plausible that a critical object 40 is hidden behind the gap 42 then a safety-related cut-off occurs following the comparison with the uncritical maximum size.

1. A 3D sensor (10) having at least one image sensor (14) for the generation of image data of a monitored region (12) and a 3D evaluation unit (28) which is adapted for the calculation of a depth map having distance pixels from the image data and for the determination of reliability values for the distance pixels, characterized by a gap evaluation unit (28) which is adapted to recognize regions of the depth map with distance pixels whose reliability value does not satisfy a reliability criteria as gaps (42) in the depth map and to evaluate whether the depth map has gaps (42) larger than an uncritical maximum size.

2. A 3D sensor (10) in accordance with claim 1, wherein the gap evaluation unit (28) is adapted for an evaluation of the size of gaps (42) by means of a largest possible geometric shape (42b) inscribed into the gap, in particular by means of a diameter of an inner circle or of a diagonal of an inner rectangle.

3. A 3D sensor (10) in accordance with claim 1 having an object evaluation unit (28) which is adapted to recognize connected regions of distance pixels as objects (40) and to evaluate the size of an object (40) by means of a smallest possible geometric shape (42a) surrounding the object (40), in particular by means of a diameter of a circumference or a diagonal of a surrounding rectangle.

4. A 3D sensor (10) in accordance with claim 3, wherein the object evaluation unit (28) is adapted to generate a binary map in a first step, said binary map records in every pixel whether the reliability value of the associated distance pixel satisfies the reliability criteria and thus whether it is occupied with a valid distance value or not, then in a further step defines partial objects (46a-e) in a single linear scanning run, in that an occupied distance pixel without an occupied neighbour starts a new partial object (46a-e) and attaches occupied distance pixels with at least one occupied neighbour to the partial object (46a-e) of an occupied neighbour and wherein in a third step, partial objects (46a-e) which have at most a preset distance to one another are combined to the object.

5. A 3D sensor (10) in accordance with claim 1, wherein the gap evaluation unit and/or the object evaluation unit is adapted to overestimate the size of a gap (42) or an object (40), in particular by projection on to the remote border of the monitored region (12) or of a work region (32).

6. A 3D sensor (10) in accordance with claim 1, wherein the gap evaluation unit (28) and/or the object evaluation unit (28) is adapted to calculate gaps (42) or objects (40) of the depth map in a single linear scanning run in real time.

7. A 3D sensor (10) in accordance with claim 1, wherein the gap evaluation unit (28) is adapted to determine the size of the gaps (42) by successively generating an evaluation map s in accordance with the calculation rule,
$$s ( x , y ) = \{ \begin{matrix}0 & when d ( x , y ) \neq 0 \\ 1 + min ( \begin{matrix}\begin{matrix}s ( x - 1 , y ) , \\ s ( x - 1 , y - 1 ) ,\end{matrix} \\ s ( x , y - 1 )\end{matrix} ) & when d ( x , y ) = 0\end{matrix}$$
wherein d(x,y)=0 is valid precisely then when the reliability value of the distance pixel at the position (x,y) of the depth map does not satisfy the reliability criterion.

8. A 3D sensor (10) in accordance with claim 1 having at least two image sensors (14a-b) for the reception of image data from the monitored region (12) from different perspectives, wherein the 3D evaluation unit (28) is adapted for the generation of the depth map and the reliability values using a stereoscopic method.

9. A 3D sensor (10) in accordance with claim 1, wherein a warning unit or cut off unit (34) is provided, by means of which by detection of gaps (42) or prohibited objects (40) larger than the uncritical maximum size a warning signal or a safety cut off command can be issued to a dangerous machine (30).

10. A 3D sensor (10) in accordance with claim 1, wherein a work region (32) is preset as a partial region of the monitored region (12) and the 3D evaluation unit (28), the gap evaluation unit (28) and/or the object evaluation unit (28) only evaluates the depth map within the work region (32).

11. A 3D monitoring process, in particular a stereoscopic monitoring process in which image data from a monitored region (12) generate depth maps having distance pixels, as well as a respective reliability value for each distance pixel, characterized in that regions of the depth map having distance pixels whose reliability values do not satisfy a reliability criterion are detected as gaps (42) in the depth map and an evaluation is made whether the depth map has gaps (42) which are larger than an uncritical maximum size.

12. A 3D monitoring process in accordance with claim 11, wherein the size of gaps (42) is evaluated by means of a largest possible inscribed geometric shape (42b), in particular by means of a diameter of an inner circle or a diagonal of an inner rectangle and/or wherein connected regions of distance pixels are recognized as objects (40) and the size of an object (40) is evaluated by means of a smallest possible shape (40a) surrounding the object, in particular by means of a diameter of a circumference or a diagonal of a surrounding rectangle.

13. A 3D monitoring process in accordance with claim 11, wherein the size of a gap (42) or an object (40) is overestimated, in particular by projection on to the remote border of the monitored region (12) or a work region (32).

14. A 3D monitoring process in accordance with claim 11, wherein the gaps (42) or objects (40) of the depth map are calculated in real time in a single linear scanning run.

15. A 3D monitoring process in accordance with claim 11, wherein on detection of gaps (42) or prohibited objects (40) larger than the uncritical maximum size a warning signal or a safety cut off command is issued to a dangerous machine (30).
